(19) United States
(12) Patent Application Publication
(10) Pub. No.: US 2006/0077629 A1
(43) Pub. Date: Apr. 13, 2006

(54) Display apparatus

(76) Inventor: Mikio Shiraishi, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/212,578

(22) Filed: Aug. 29, 2005

(30) Foreign Application Priority Data
Oct. 8, 2004 (JP) 2004-296652

(51) Int. Cl. G06F 1/16; H04N 5/64

(52) U.S. Cl. 361/681; 248/917; 348/794; 348/836

(57) ABSTRACT

The present invention allows a display apparatus employing a flat panel display device to have a simple, low-cost construction. The display in the display apparatus of the present invention comprises: a flat panel display device; and a frame member including a frame-shaped first portion and a second portion that are formed integrally within the frame member, the first portion surrounding the circumference of the flat panel display device, the second portion being disposed inside the first portion and supporting the rear side of the flat panel display device thereon. The frame member may further include a third portion connectable to a support base, and the first to third portions may be integrally formed within the frame member.

### CLAIM OF PRIORITY

The present application claims priority from Japanese application serial no. P2004-296652, filed on Oct. 8, 2004, the content of which is hereby incorporated by reference into this application.

### BACKGROUND OF THE INVENTION

(1) Field of the Invention

The present invention relates to the configuration of a display apparatus that uses a flat panel display device to display a television image, etc.

(2) Description of the Related Art

Display apparatuses such as TV receivers have been improved with the advance of display technology. For instance, efforts have been made to develop and manufacture thin display apparatuses by using a flat panel display device such as a liquid crystal display (hereinafter referred to as an “LCD”) panel or a plasma display panel (hereinafter referred to as a “PDP”). Furthermore, the size of display monitors using a flat panel display device has been increased; for example, large-size panels such as 50-inch (1270×10⁻³ m) diagonal panels have been available.

The increase in the size of the monitors has made it necessary to ensure the strength of their flat panel display devices since the primary members of these panels are made of glass. For example, a flat panel display device might be cracked or damaged by impact force applied to its front or by impact force applied to it through its support when the display apparatus is accidentally dropped. To prevent this from happening, various measures have been considered.

A flat panel display device, predominantly made of glass, is often provided with metal members on its rear side for supporting and thereby reinforcing the panel so as to compensate for the lack of strength of the glass. Conventional techniques for reinforcing a flat panel display device are described, for example, in Japanese Patent Laid-open Nos. 2002-99218 (patent document 1), 2002-189426 (patent document 2), 11-119678 (patent document 3), and 07-322171 (patent document 4).

### SUMMARY OF THE INVENTION

The technique disclosed in patent document 1 adds bent ribs to the metal plate for reinforcing the rear of the flat panel display device so as to increase strength. This technique, however, cannot provide sufficient strength to the entire portion of the display apparatus including its enclosure, even though the panel alone can be easily reinforced. The technique disclosed in patent document 2 employs reinforcing frames, in addition to the metal plate for reinforcing the rear of the flat panel display device, to increase the strength of the entire display apparatus. However, since the reinforcing frames and the metal plate for reinforcing the rear of the flat panel display device are provided as separate components, this technique may be disadvantageous in terms of parts count, device cost, device size, etc. The technique disclosed in patent document 3 joins the metal rear plate to the rear chassis, which constitutes part of the equipment chassis, to achieve sufficient strength. This technique can provide strength while reducing the parts count. However, when the display apparatus is reassembled due to maintenance, etc., the screws might not be fully tightened, making it difficult to reliably provide sufficient strength. Further, the technique described in patent document 4 employs an equipment chassis with high strength and mounts the flat panel display device in it to ensure adequate strength of the entire display apparatus. This technique allows the entire display apparatus to have sufficient strength. However, since the chassis itself has a structure to reinforce the flat panel display device, it has increased dimensions, making it difficult to reduce the overall dimensions of the display apparatus.

In view of the above problems of the prior art, it is an object of the present invention to provide a display apparatus employing a flat panel display device as its display, in which the flat panel display device is reliably reinforced and supported using a simple configuration while preventing an increase in the dimensions. That is, the present invention provides a display apparatus that is easy to manufacture and whose cost can be reduced.

The present invention provides a display apparatus including a display connectable to a support base, the display comprising: a flat panel display device; and a frame member including a frame-shaped first portion (constituting an exterior portion of the display apparatus) and a second portion that are formed integrally within the frame member, the first portion surrounding the circumference of the flat panel display device, the second portion being disposed inside the first portion and supporting the rear side of the flat panel display device thereon. The frame member may further include a third portion connectable to the support base, and the first to third portions may be integrally formed within the frame member. Further, the first portion may constitute an exterior portion of the display apparatus.

The present invention allows a display apparatus employing a flat panel display device to have a simple configuration in which the-flat panel display device is provided with sufficient strength while preventing an increase in the dimensions. Thus, according to the present invention, it is possible to provide a compact, low-cost display apparatus which is easy to manufacture.

### BRIEF DESCRIPTION OF THE DRAWINGS

FIG. 1 is a perspective view of a display apparatus according to a first embodiment of the present invention;

FIG. 2 is an exploded view showing the internal configuration of the display apparatus shown in FIG. 1;

FIG. 3 is a detailed view of a frame member in the configuration shown in FIG. 2;

FIG. 4 is a cross-sectional view showing the connections between the components around the flexible cable in the configuration shown in FIG. 2;

FIGS. 5A and 5B illustrate the support base mounting structure of the display apparatus shown in FIG. 1;

FIG. 6 is an exploded view showing the internal configuration of a display apparatus according to a second embodiment of the present invention;

FIG. 7 is a detailed diagram showing the frame member in the configuration shown in FIG. 6;

FIG. 8 is a cross-sectional view showing the connections between the components around the flexible cable in the configuration shown in FIG. 6;

FIGS. 9A and 9B illustrate the support base mounting structure of the display apparatus of the second embodiment.

### DETAILED DESCRIPTION OF THE PREFERRED EMBODIMENTS

Preferred embodiments of the present invention will be described below with reference to the accompanying drawings. It should be noted that in all figures, like numerals are used to denote components having like functions, and for simplicity their explanation will not be repeated.

### First Embodiment

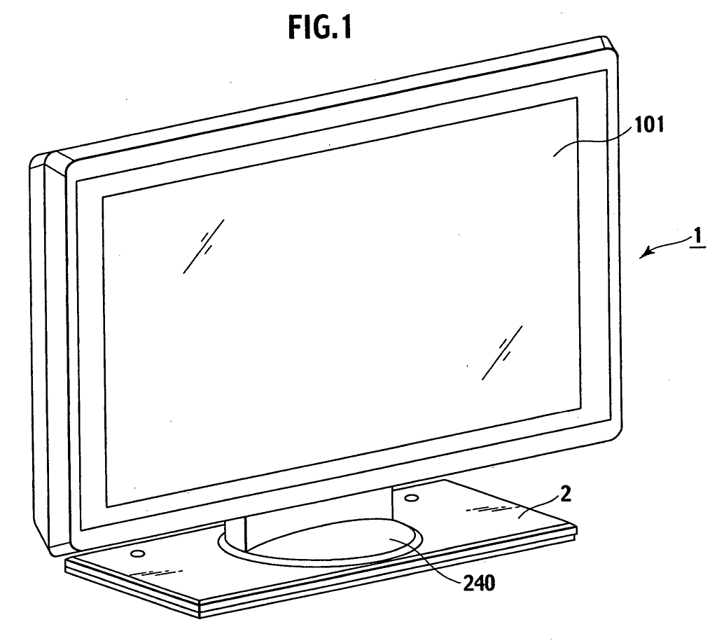

FIGS. 1 to 5 illustrate a first embodiment of the present invention. FIG. 1 is a perspective view of a display apparatus according to the first embodiment of the present invention. Referring to the figure, a display apparatus 1 is configured such that a display 101 is joined to and thereby supported by a support base 2. The display 101 in the display apparatus 1 is made up of a flat panel display device such as a PDP and displays a television image, etc. The following description assumes that the display 101 has a thin configuration.

The display 101 in the display apparatus 1 displays an image according to a signal received from tuner means (not shown) or video reproduction means (not shown). The support base 2 is provided with a turning means 240 thereon to two- or three-dimensionally turn the display 101 relative to the support base 2, allowing the viewing direction to be adjusted.

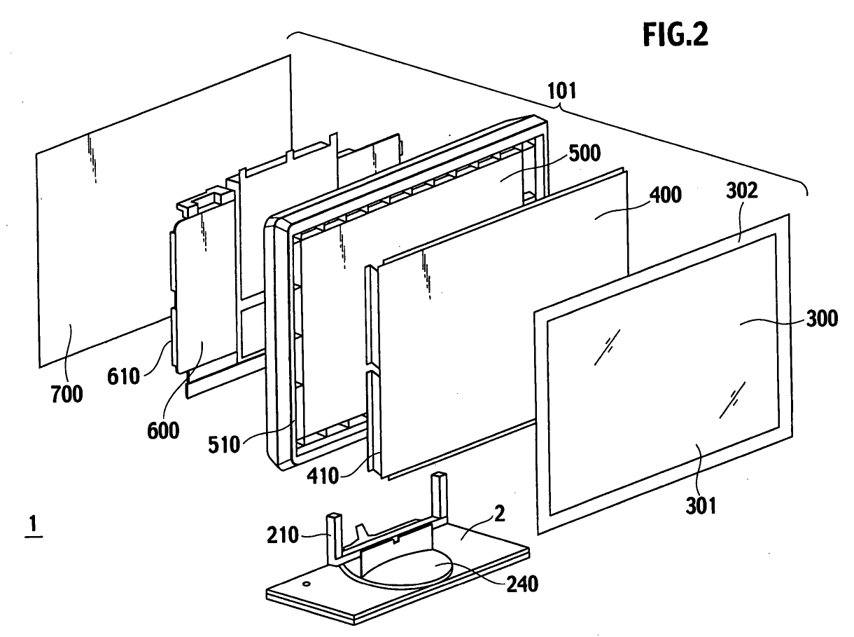

FIG. 2 is an exploded view showing the internal configuration of the display apparatus 1 shown in FIG. 1.

The display 101 in the display apparatus 1 is made up primarily of a flat panel display device 400 (a PDP, etc.) for image display. Within the display 101, an optical filter member 300 is provided on the front side of the flat panel display device 400 to reduce reflection of external light. The optical filter member 300 is made up of a transparent portion 301 and a shielding portion 302, and the flat panel display device 400 can be seen through the transparent portion 301. A frame member 500 is mounted on the rear side of the flat panel display device 400 through a double-faced adhesive, etc. A circuit board 600 is attached to the rear of the frame member 500. The circuit board 600 has a drive circuit mounted thereon to drive the flat panel display device 400 according to an image signal. The circuit board 600 and the flat panel display device 400 are connected to each other by a flexible cable 410 acting as a connection conductor.

Specifically, the flexible cable 410 is passed through a throughhole or connection hole 510 in the frame member 500 and connected to a connector 610 of the circuit board 600. Further, a back cover 700 is disposed on the rear side of the circuit board 600 and attached to the frame member 500 such that the back cover 700 covers the circuit board 600. The back cover 700 is also one of the exterior parts of the display apparatus. The frame member 500 is joined to the support base 2.

The frame member 500 may be produced, for example, by molding a polymeric material. The frame member 500 includes: a frame-shaped portion (a first portion) surrounding the circumference of the flat panel display device 400; a second portion disposed inside the frame-shaped portion and supporting the rear side of the flat panel display device 400 thereon through a double-faced adhesive, etc. in such a way as to reinforce the flat panel display device 400; a third portion to be joined to the support base 2; a fourth portion supporting the circuit board 600, this portion being disposed on the side opposite to the second portion which supports the flat panel display device 400 in such a way as to reinforce it; a fifth portion to which the back cover 700 is attached; and a sixth portion supporting the optical filter member 300. The above first to sixth portions are integrally formed within a single member, namely the frame member 500. That is, the frame member 500 is formed such that it includes several shapes and structures. Further, according to the first embodiment, the frame-shaped first portion of the frame member 500, together with the back cover 700 and the optical filter member 300, constitutes the exterior portion of the display apparatus 1.

The entire display apparatus is supported on the support base 2. The display 101 is joined to the support base 2 by use of connection bosses 210 on the support base 2. The connection bosses 210 are engaged with the mounting portions of the frame member 500 in the display 101 and fixed by screws, etc.

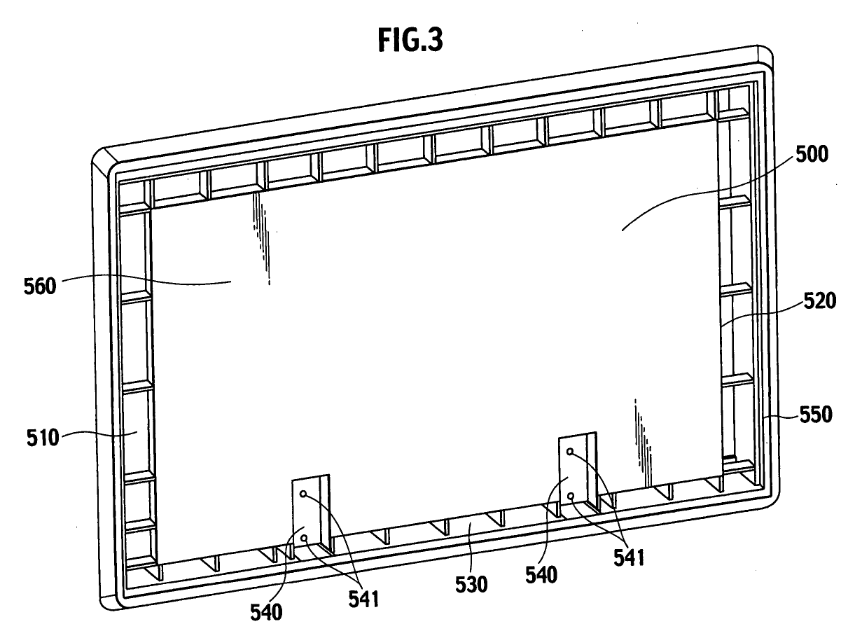

FIG. 3 is a perspective view showing the details of the frame member 500.

The frame member 500 has a function of supporting the flat panel display device 400. Specifically, the frame member 500 supports the flat panel display device 400 on its flat panel display device support portion 560 through a double-faced adhesive (not shown), etc. The frame member 500 has throughholes 510, 520, and 530 through which the flexible cable 410 is passed. The flexible cable 410 is run from the flat panel display device 400 on the front side to the circuit board 600 on the rear side through these throughholes and connected to the circuit board 600. Further, the frame member 500 has mounting portions 540 for connecting the support base 2 to the frame member 500. The support base 2 is mounted on the far side of the figure. Each mounting portion 540 has mounting screw holes 541 for fixing the support base 2 using screws. The frame member 500 also includes an exterior portion 550 that constitutes part of the exterior of the display apparatus.

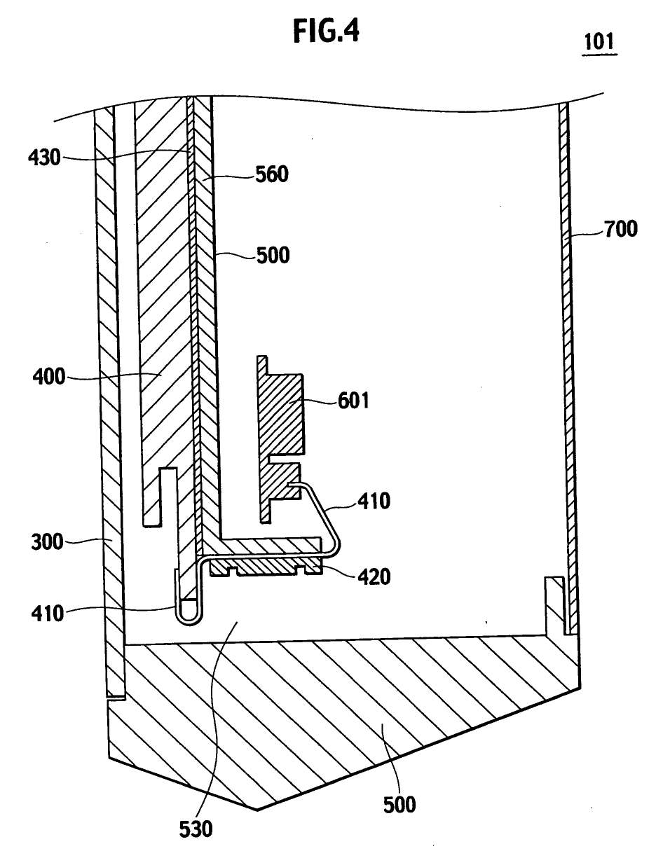

FIG. 4 is a cross-sectional view showing the connections between the components around the flexible cable 410 in the display apparatus of the first embodiment.

Referring to the figure, the flat panel display device 400 and the drive circuit board 601 that constitutes part of the circuit board 600 are connected to each other by the flexible cable 410 passed through the throughhole 530 provided in the frame member 500. A drive IC 420 is connected to the flexible cable 410 at a point halfway between the flat panel display device 400 and the drive circuit board 601. The drive IC 420 is attached to the inner wall of the throughhole 530. The flat panel display device 400 is attached to the flat panel display device support portion 560 of the frame member 500 through a double-faced adhesive 430. Thus, the frame member 500 supports and thereby reinforces the rear of the flat panel display device 400, protecting the panel from being damaged due to external force such as a pressure applied to its front or vibration.

The circuit board 600 is provided on the rear side of the frame member 500; it is attached to and supported by a support provided on the frame member 500.

In the display apparatus 1 of the present embodiment, the frame member 500, the back cover 700, and the optical filter member 300 also function as exterior parts. The back cover 700 and the optical filter member 300 are attached to the frame member 500. Thus, the display apparatus 1 is constructed such that components are mounted around the frame member 500.

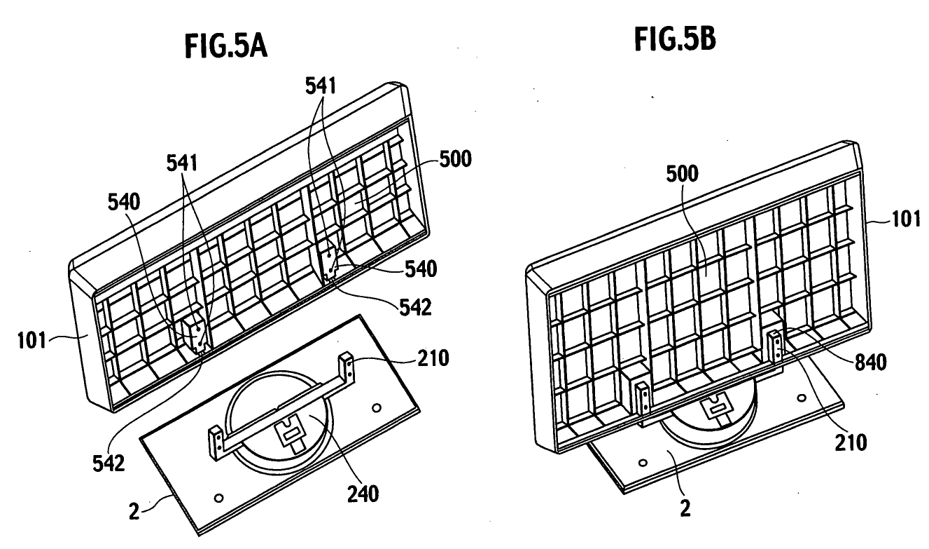

FIGS. 5A and 5B illustrate the support base mounting structure of the display apparatus 1 of the present embodiment. Specifically, FIG. 5A is an exploded view of the support base mounting structure, and FIG. 5B is a perspective view showing how the display 101 is mounted on the support base 2.

The display 101 in the display apparatus 1 is connected to the support base 2 by attaching the connection bosses 210 of the support base 2 to the mounting portions 540 of the frame member 500, as shown in FIG. 5B.

Specifically, the connection bosses 210 of the support base 2 are inserted into support holes 542 provided in the frame member 500 and then fixed to the mounting portions 540 of the frame member 500 by screwing screws into mounting screw holes 541. Connecting the display 101 in the display apparatus 1 to the support base 2 results in the entire display apparatus 1 being supported on the support base 2. That is, as described with reference to FIG. 4, the display apparatus 1 is constructed such that related components making up the display 101 are mounted around the frame member 500. Therefore, connecting the frame member 500 to the support base 2 results in the entire display apparatus 1 being supported on the support base 2.

According to the first embodiment, as described with reference to FIGS. 1 to 4, 5A and 5B, the frame member 500 in the display 101 includes: the frame-shaped portion, i.e., the first portion, surrounding the circumference of the flat panel display device 400; the second portion supporting and thereby reinforcing the flat panel display device 400; the third portion to be joined to the support base 2; the fourth portion supporting the circuit board 600; the fifth portion to which the back cover 700 is attached: and the sixth portion supporting the optical filter member 300. These first to sixth portions are integrally formed within a single member, namely the frame member 500. Further, the frame-shaped portion, i.e., the first portion, constitutes an exterior portion of the display apparatus 1. These arrangements allow the device to have a simple, compact, and lightweight construction, resulting in reduced cost.

### Second Embodiment

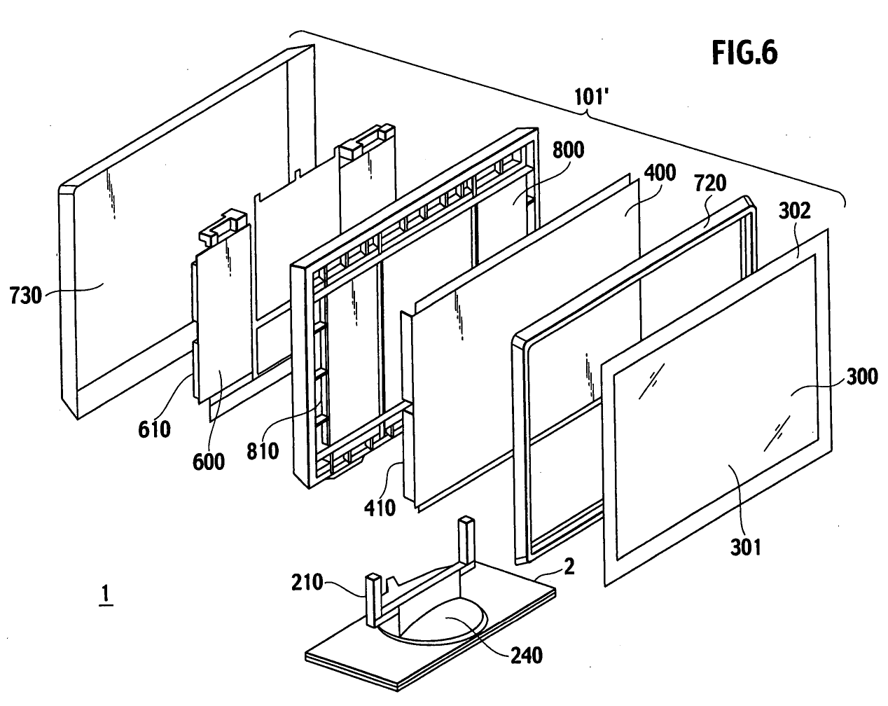

FIGS. 6 to 9 illustrate a display apparatus according to a second embodiment of the present invention. FIG. 6 is an exploded view showing the internal configuration of the display apparatus 1′ of the second embodiment.

The display apparatus 1′ is made up of: a display 101′ including a flat panel display device 400 (a PDP, etc.) for display; and a support base 2 supporting the display 101′. The display 101′ displays an image according to a signal received from tuner means (not shown) or video reproduction means (not shown). The support base 2 is provided with a turning means 240 thereon capable of two- or three-dimensionally turning the display 101′ relative to the support base 2, allowing the viewing direction to be adjusted. An optical filter member 300 is disposed on the front side of the display 101 to reduce reflection of external light. The optical filter member 300 is made up of a transparent portion 301 and a shielding portion 302, and the flat panel display device 400 can be seen through the transparent portion 301. A frame member 800 is mounted on the rear side of the flat panel display device 400 through a double-faced adhesive, etc. The optical filter member 300 is attached to the frame member 800 by way of a front frame 720. The frame member 800 is connected to the support base 2 by use of the mounting portions of the frame member 800.

A plurality of circuit boards 600 are provided on the rear side of the frame member 800. The circuit boards 600 and the flat panel display device 400 are connected to each other by a flexible cable 410. Specifically, the flexible cable 410 is passed through a throughhole 810 in the frame member 800 and connected to a connector 610 for the circuit boards 600. Further, a back cover 730 is disposed on the rear side of the circuit boards 600. The back cover 730 is an exterior part of the display apparatus.

The frame member 800 may be produced, for example, by molding a polymeric material. The frame member 800 includes: a frame-shaped portion (first portion) surrounding the circumference of the flat panel display device 400; a second portion disposed inside the frame-shaped portion (first portion) and supporting the rear side of the flat panel display device 400 thereon through a double-faced adhesive, etc. in such a way as to reinforce the flat panel display device 400; a third portion to be joined to the support base 2; a fourth portion supporting the circuit boards 600, this portion being disposed on the side opposite to the second portion which supports the flat panel display device 400 in such a way as to reinforce it; a fifth portion to which the back cover 730 is attached; and a portion to which the front frame 720 is attached. These portions are integrally formed within a single member. The back cover 730 is disposed such that it covers the circuit boards 600 and the frame-shaped portion (first portion). According to the second embodiment, the back cover 730, the front frame 720, and the optical filter member 300 constitute the exterior portion of the display apparatus.

The entire display apparatus is supported on the support base 2. The display 101′ is joined to the support base 2 by use of connection bosses 210 provided on the support base 2. The connection bosses 210 are engaged with the mounting portions of the frame member 800 in the display 101′ and fixed by screws, etc.

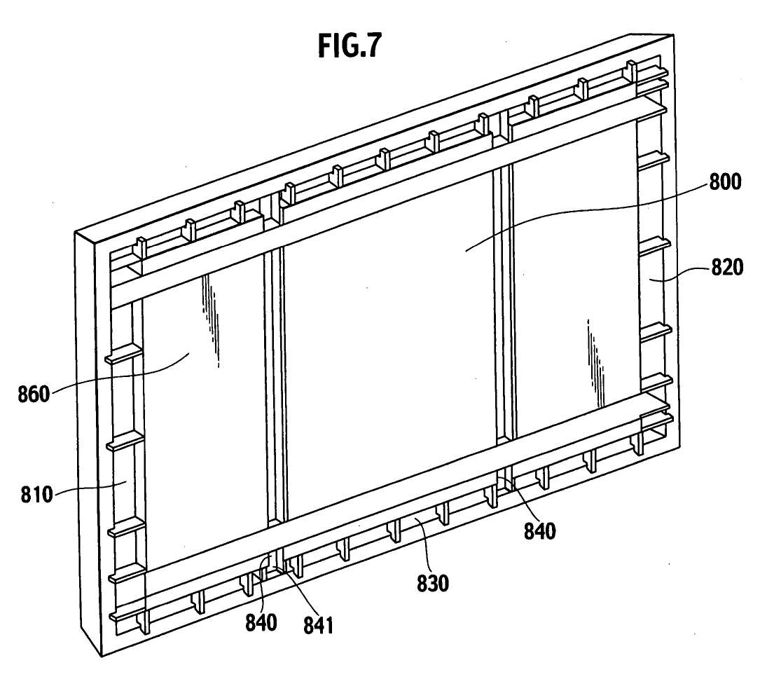

FIG. 7 is a perspective view of the frame member 800. The frame member 800 has a function of supporting the flat panel display device 400. Specifically, the frame member 800 supports the flat panel display device 400 on its flat panel display device support portion 860 through a double-faced adhesive (not shown), etc. in such a way as to reinforce the flat panel display device 400. The frame member 800 has throughholes 810, 820, and 830 through which the flexible cable 410 acting as a connection conductor is passed. The flexible cable 410 is run from the flat panel display device 400 on the front side to the circuit boards 600 on the rear side through these throughholes and connected to the circuit boards 600. Further, the frame member 800 has mounting portions 840 for connecting the support base 2 to the frame member 800. The support base 2 is mounted on the far side of the figure. Each mounting portion 840 has mounting screw holes 841 for fixing the support base 2 using screws.

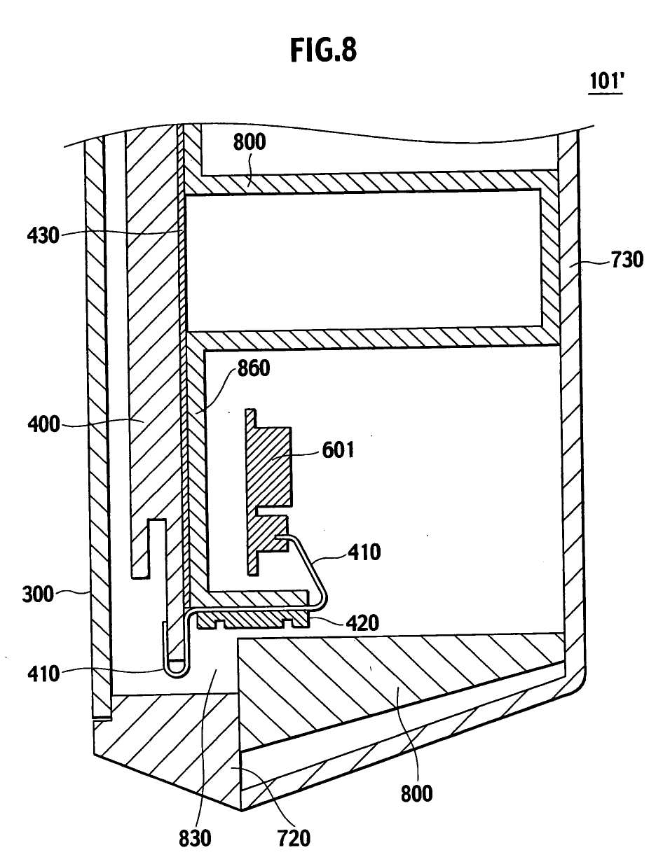

FIG. 8 is a cross-sectional view showing the connections between the components around the flexible cable within the display apparatus 1′ of the second embodiment. The flat panel display device 400 and drive circuit boards 601 that each constitute part of a circuit board 600 are connected to each other by the flexible cable 410 passed through the throughhole 830 provided in the frame member 800. A drive IC 420 is connected to the flexible cable 410 at a point halfway between the flat panel display device 400 and the drive circuit boards 601. The drive IC 420 is attached to the inner wall of the throughhole 830.

The flat panel display device 400 is attached to the flat panel display device support portion 860 of the frame member 800 through a double-faced adhesive 430. Thus, the frame member 800 reinforces the rear of the flat panel display device 400, protecting the panel from being damaged due to external force such as a pressure applied to its front or vibration. Each circuit board 600 provided on the rear side of the frame member 800 is attached to and supported by a support provided on the frame member 800.

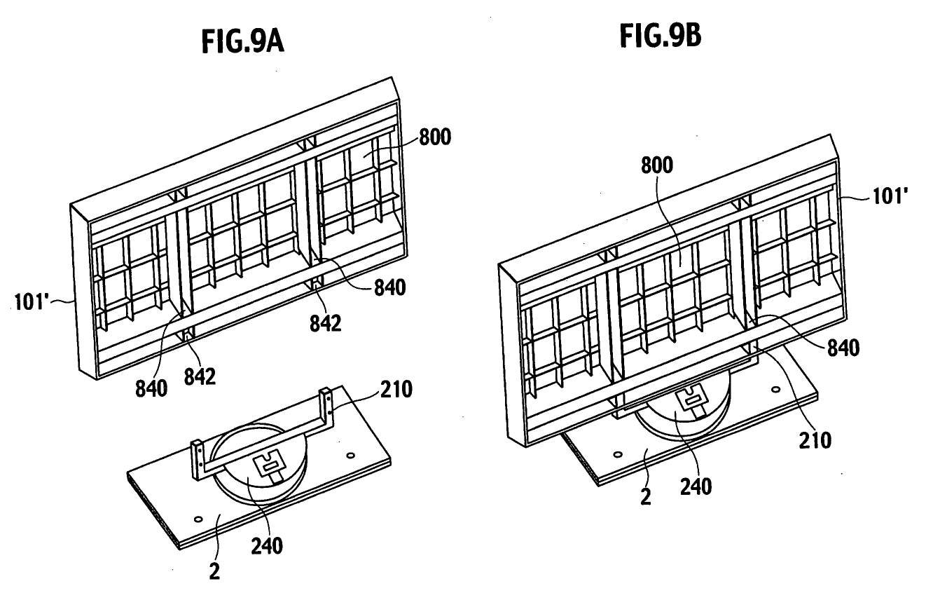

FIGS. 9A and 9B illustrate the support base mounting structure of the display apparatus 1′ of the second embodiment. Specifically, FIG. 9A is an exploded view of the support base mounting structure, and FIG. 9B is a perspective view showing how the display 101′ is mounted on the support base 2. The display 101′ in the display apparatus 1′ is connected to the support base 2 by attaching the connection bosses 210 of the support base 2 to the mounting portions 840 of the frame member 800, as shown in FIG. 9B. Specifically, the connection bosses 210 of the support base 2 are inserted into support holes 842 provided in the frame member 800 and then fixed to the mounting portions 840 by screwing screws into mounting screw holes 841. Connecting the display 101′ to the support base 2 results in the entire display apparatus being supported on the support base 2. That is, since the display 101′ in the display apparatus 1′ is constructed such that components are mounted around the frame member 800, connecting the frame member 800 to the support base 2 results in the entire display apparatus being supported on the support base 2.

According to the second embodiment, as described with reference to FIGS. 6 to 8, 9A and 9B, the frame member 800 in the display 101′ includes: the frame-shaped portion (first portion) surrounding the circumference of the flat panel display device 400; the second portion supporting and thereby reinforcing the flat panel display device 400; the third portion to be joined to the support base 2; the fourth portion supporting the circuit boards 600; the fifth portion to which the back cover 730 is attached; and the portion supporting the front frame 720. These portions are integrally formed within a single member. This arrangement allows the device to have a simple, compact, and lightweight construction, resulting in reduced cost.

It should be noted that the flat panel display device 400 may be a liquid crystal panel, a field emission panel, or a light emitting diode panel, instead of a PDP. Further, the displays may be liquid crystal displays (LCDs) using a liquid crystal display panel, field emission displays (FEDs) using a field emission panel, electron emission displays using an electron emission panel, or light emitting diode displays (or electroluminescent displays) using a light emitting diode panel.

Further, the material of the frame members is not limited to polymeric materials. For example, they may be made of a metal material. In such a case, the frame members may be produced by press working. Still further, even though in the above embodiments the support base 2 is mounted under the displays 101 and 101′, the present invention is not limited to this particular arrangement. The support base 2 may be mounted on a lateral side or on the top side of the displays 101 and 101′.

What is claimed is:

1. A display apparatus including a display connectable to a support base, said display comprising:
a flat panel display device for image display; and
a frame member including a frame-shaped first portion and a second portion that are formed integrally within said frame member, said frame-shaped first portion surrounding a circumference of said flat panel display device, said second portion being disposed inside said first portion and supporting the rear side of said flat panel display device thereon.

2. The display apparatus as claimed in claim 1, wherein:
said frame member further includes a third portion connectable to said support base; and
said first to third portions are integrally formed within said frame member.

3. A display apparatus including a display connectable to a support base, said display comprising:
a flat panel display device for image display;
an optical filter member disposed on the front side of said flat panel display device;
a circuit board having mounted thereon a drive circuit for driving said flat panel display device;
a back cover covering said circuit board; and
a frame member including:
a frame-shaped first portion surrounding a circumference of said flat panel display device;
a second portion disposed inside said first portion and supporting the rear side of said flat panel display device thereon;
a third portion connectable to said support base;
a fourth portion disposed on a side opposite to said second portion and supporting said circuit board;
a fifth portion to which said back cover is attached; and
a sixth portion supporting said optical filter member;
wherein said first to sixth portions are integrally formed within said frame member.

4. A display apparatus including a display connectable to a support base, said display comprising:
a flat panel display device for image display; and
a frame member including a first portion and a second portion that are formed integrally within said frame member, said first portion constituting an exterior portion of said display apparatus, said second portion being disposed inside said first portion and supporting the rear side of said flat panel display device thereon.

5. The display apparatus as claimed in claim 4, wherein:
said frame member further includes a third portion connectable to said support base; and
said first to third portions are integrally formed within said frame member.

6. A display apparatus including a display connectable to a support base, said display comprising:
a flat panel display device for image display;
an optical filter member disposed on the front side of said flat panel display device;
a circuit board having mounted thereon a drive circuit for driving said flat panel display device;
a back cover covering said circuit board; and
a frame member including:
a first portion constituting an exterior portion of said display apparatus;
a second portion disposed inside said first portion and supporting the rear side of said flat panel display device thereon;
a third portion connectable to said support base;
a fourth portion disposed on a side opposite to said second portion and supporting said circuit board;
a fifth portion to which said back cover is attached; and
a sixth portion supporting said optical filter member;
wherein said first to sixth portions are integrally formed within said frame member.

7. The display apparatus as claimed in claim 6, wherein said frame member is formed of a polymeric material.

8. The display apparatus as claimed in claim 6, wherein:
said third portion has connecting means with which a connecting portion of said support base is engaged; and
said frame member is connectable to said support base through said connecting means.

9. The display apparatus as claimed in claim 6, wherein said frame member has a throughhole through which a connection conductor is passed to connect between said flat panel display device and said circuit board.
